(19) United States
(12) Patent Application Publication
(10) Pub. No.: US 2019/0161086 A1
(43) Pub. Date: May 30, 2019

(54) METHOD AND MECHANISM FOR ASSISTED PERFORMANCE OF A REVERSE-TURNING MANEUVER OF A VEHICLE

(71) Applicant: FORD GLOBAL TECHNOLOGIES, LLC, Dearborn, MI (US)

(72) Inventor: Timothy C. BETTGER, Aachen NRW (DE)

(73) Assignee: FORD GLOBAL TECHNOLOGIES, LLC, Dearborn, MI (US)

(21) Appl. No.: 16/203,155

(22) Filed: Nov. 28, 2018

(30) Foreign Application Priority Data
Nov. 29, 2017 (DE) 10 2017 221 398.1

(51) Int. Cl. B60W 30/18; B60W 50/14; B62D 15/02

(52) U.S. Cl. CPC B60W 30/18036; B60W 50/14; B62D 15/029; B60W 2720/10; B60W 2050/146; B60W 2720/24; B60W 2710/202; B62D 15/025

(57) ABSTRACT

A method and apparatus for the assisted performance of a reverse-turning maneuver of a vehicle. When it is determined that the vehicle is reversing, non-contact sensors detect spatial conditions in the surroundings of the vehicle. A computer processor determines whether the detected spatial conditions allow a reverse-turning maneuver and outputs a signal if the spatial conditions allow a reverse-turning maneuver. The processor may further calculate a route for carrying out the reverse-turning maneuver, and at least one of a steering angle, a steering torque, and a vehicle speed for traversing the determined route provides information. The above information is utilized by a vehicle dynamics controller to achieve autonomous operation of at least one vehicle dynamics system (steering system, brake system, drivetrain system, etc.) to perform the maneuver.

### CROSS-REFERENCE TO RELATED APPLICATIONS

This application claims foreign priority benefits under 35 U.S.C. § 119(a)-(d) to DE Application 10 2017 221 398.1 filed Nov. 29, 2017, which is hereby incorporated by reference in its entirety.

### TECHNICAL FIELD

The present invention concerns a method and a mechanism for the assisted performance of a reverse-turning maneuver of a vehicle

### BACKGROUND

In most cases, vehicles are reversed (operated to travel in a rearward direction, also known as “backing up”) at speeds lower than when travelling. The low speed is appropriate because the rearward visibility of the vehicle driver is limited or restricted, as compared to driving in a forward direction. In addition, the stability of the vehicle may be reduced as compared with forward driving, because the steerable front wheels become, in effect, the rear wheels when reversing. These considerations generally cause vehicle manufacturers to provide electronic speed limiting during reversing.

Moreover, most vehicle drivers prefer to turn the vehicle through 180° so that the vehicle may travel forward instead of reversing over longer distances, especially if there are obstacles along the route, such as parked automobiles for example. However, there is the problem with this of finding a suitable opportunity for carrying out the reverse-turning maneuver, in particular in restricted/obstructed spatial conditions.

A method and a system for assisting a driver when parking or maneuvering a motor vehicle are known from WO 2007/074113 Al. With the method described, detection of the surroundings is first carried out by means of a driver assistance system. A target path is then calculated in a calculation model, wherein monitoring and determining the differences in circumference between the individual wheels are carried out by means of a vehicle safety system and the target path is predicted in a calculation model by using the differences in circumference.

DE 10 2004 027 250 A1 also discloses a method for assisted control, in particular for assisted maneuvering and parking of a motor vehicle, wherein a target driving path with a starting point and a destination is defined, the target driving path is output and the motor vehicle is moved. In the event of a deviation of the actual position from the target driving path, a corrected target driving path is output.

Moreover, a method for controlling an automatic gearbox by means of an electronic control unit in a motor vehicle during a spinning turn is known from DE 10 2014 207 368 A1.

### SUMMARY

The present disclosure specifies a method and a mechanism, with which a driver can be assisted when reversing and carrying out a reverse-turning maneuver. In particular, safe and rapid performance of a reverse-turning maneuver is enabled. The reverse-turning maneuver can preferably be carried out partly autonomously or fully autonomously, and as a result the ride comfort for the driver of the vehicle can be increased.

The rapid performance of a reverse-turning maneuver can in particular be important for emergency vehicles, such as for example police, fire service or health service vehicles, because lengthy driving maneuvers, such as for example reversing over long distances or searching for a suitable place for carrying out a reverse-turning maneuver by the driver of the vehicle, are dispensed with and the deployment location can be reached faster.

A method for the assisted performance of a reverse-turning maneuver of a vehicle comprises the steps described below. The term “assisted,” as used herein, is defined as meaning that the driver of the vehicle is given at least one means of assistance, for example in the form of a signal output. “Assisted” is further intended to include partially or fully autonomous performance of a reverse-turning maneuver, during which some or all steps are performed autonomously by the vehicle itself (under the control of an electronic control unit such as a vehicle dynamics controller, for example) without the involvement of the driver of the vehicle.

It is first determined whether the vehicle is reversing. The determination can be carried out by computer, for example by means of an electronic control unit. For example, the speed of the vehicle and/or the engagement of the reverse gear of the vehicle transmission may be checked. If it is determined that the vehicle is not reversing, then the procedure of determining whether the vehicle is reversing is repeated until reversing is detected or the process is terminated.

When vehicle reversing is detected, in a next step the spatial conditions in the surroundings of the vehicle are detected, in particular to the side and rear of the vehicle. Spatial conditions are understood to include the presence of any object(s)/obstruction(s) adjacent to the vehicle and the distance(s) to any such object(s)/obstacle(s). For detecting the spatial conditions, various non-contact sensors, for example radar sensors and/or distance(s) to LIDAR (light detection and ranging) sensors can be used, which can be mounted to (onboard) the vehicle. As is well known in the art, such non-contact sensors are able to detect, to a high degree of accuracy, the presence of and distances to various types of objects/obstructions adjacent to a vehicle.

It is then determined by a computer whether the detected spatial conditions allow a reverse-turning maneuver. Vehicle data stored in a memory unit, such as for example the radius of the turning circle of the vehicle and/or stored data relating to the spatial requirements for performing a reverse-turning maneuver, may be used for this purpose. For example, using the sensor data an estimate of the spatial conditions behind the vehicle can be produced. If said spatial conditions enable the performance of a speed-dependent and/or vehicle-dependent driving maneuver for which calibrated values or trajectories are stored in the control unit, the maneuver is allowed.

If the spatial conditions do not allow a reverse-turning maneuver, the detected spatial conditions are continuously checked until the detected spatial conditions allow a reverse-turning maneuver or the procedure is terminated.

If it is determined that the spatial conditions permit a reverse-turning maneuver, a signal is output. For example, the signal can be an optical, haptic or acoustic signal for the driver of the vehicle, to whom it is thereby signaled that the spatial conditions allow the performance of a reverse-turning maneuver.

Alternatively, or in addition, the signal can be output in the form of a control signal, which triggers the performance of the reverse-turning maneuver by autonomous control of one or more systems of the vehicle, for example, by altering the steering angle, the steering torque, the speed, the engaged gear, etc.

According to various embodiments, the method can further include computerized determination and outputting instructions for use in autonomous performance of the reverse-turning maneuver. The instruction may comprise a route for carrying out the reverse-turning maneuver. In this case, a route means a target path that the vehicle is intended to follow for carrying out the reverse-turning maneuver. When determining the route, vehicle-specific data can be taken into account, for example the current direction of motion, position and speed of the vehicle and the data of a yaw rate sensor, a steering angle sensor and/or engine/motor rpm sensors. The determined route may be output to the driver of the vehicle by means of a man-machine interface, for example, in the form of a display representation, and/or to a vehicle control unit for carrying out the reverse-turning maneuver according to the determined route.

In one embodiment, the route may be monitored when carrying out the reverse-turning maneuver, regardless of whether said maneuver is carried out by the driver of the vehicle, partly or fully autonomously, for example, by means of sensors such as radar sensors or LIDAR sensors. If an obstacle is detected along the route, then an alternative route with which the obstacle can be bypassed can be determined and output. If bypassing the obstacle is not possible, the vehicle can be decelerated automatically, for example by means of the service brake.

The instructions determined and output by the processing unit may further comprise steering angles, steering torques and/or speeds for traversing the determined route. In other words, those parameters are determined and output that are to be maintained with no or a small deviation for traversing the route. The determined parameters can thus be output (communicated) to the driver of the vehicle and/or a vehicle control unit, wherein the vehicle control unit controls the corresponding devices of the vehicle according to the determined parameters.

By this means, partly or fully autonomous performance of the reverse-turning maneuver can be enabled, whereby the speed of carrying out the reverse-turning maneuver and the safety can be improved.

According to further embodiments, it can be provided that the reverse-turning maneuver is only carried out following confirmation by the driver of the vehicle. The confirmation by the driver of the vehicle can for example be carried out by operating a button or by means of voice input. By this means, unintentional performance of a reverse-turning maneuver can advantageously be prevented, for example, if the rearward approach to an object, for example a loading ramp, is desired.

According to various embodiments, the reverse-turning maneuver can be a J-turn, a U-turn or a spinning turn. A J-turn or a double-L-turn means a turn, i.e., a rotation of the vehicle through 180° to change the driving direction into the driving direction opposite to the original driving direction, for which the route to be traversed for carrying out the reverse-turning maneuver has the shape of the capital letter J or the shape of a double capital letter L.

A spinning turn shall mean a turn by rotation about the vertical axis or yaw axis of the vehicle by approximately 180°.

The identified type of reverse-turning maneuver may be taken into account during determination of whether the detected spatial conditions permit a reverse-turning maneuver. For this purpose, the spatial requirement that is needed for a certain reverse-turning maneuver can be stored in a memory unit, from where the spatial requirement can be called up and compared with the detected actual spatial conditions.

If the spatial conditions allow more than one type reverse-turning maneuver, then a choice of possible reverse-turning maneuvers can be output to the driver of the vehicle. From the possible reverse-turning maneuvers, the driver of the vehicle can then select a reverse-turning maneuver that he prefers.

According to further embodiments, the speed of the vehicle and/or the drive torque of the engine/motor can be limited depending on the detected spatial conditions, for example, when carrying out the reverse-turning maneuver. If the detected spatial conditions are spacious, i.e. there is no risk of a collision or no more than a small risk of a collision, high speeds or drive moments can be permitted. If, on the other hand, the spatial conditions are constricted, for example, on a narrow street, the speed or the drive moment can be more restricted. If the spatial conditions change, then a corresponding adjustment of the maximum speed or the maximum drive moment can be carried out. In other words, the restriction of the speed of the vehicle and/or the drive moment can be carried out dynamically.

The restriction of the speed and/or the drive torque increases safety, because the risk of a collision can be reduced.

The restriction of the speed and/or the drive moment can also be carried out in order to provide the necessary period of time for determining whether the detected spatial conditions allow a reverse-turning maneuver. As a result, it can be prevented that the computerized determination of whether the detected spatial conditions allow a reverse-turning maneuver results in the spatial conditions allowing a reverse-turning maneuver, but said maneuver being unable to be carried out because the vehicle has already passed the point envisaged for carrying out the reverse-turning maneuver.

Also disclosed herein is a mechanism for the assisted performance of a reverse-turning maneuver of a vehicle, comprising means, for example, sensors, for detecting a reversing movement of the vehicle, sensors for detecting spatial conditions in the surroundings of the vehicle, and a processing unit operative to determine whether the detected spatial conditions allow a reverse-turning maneuver and to output a signal if the spatial conditions allow a reverse-turning maneuver. The signal can for example be output to a driver of the vehicle and/or as control signals for partly or fully autonomous performance of the reverse-turning maneuver.

If the signal is output to the driver of the vehicle, then the mechanism can comprise an output device such as a human/machine interface, for example, a display or a loudspeaker.

The disclosed mechanism can, for example, be suitable for carrying out the method according to the invention that is described above. Therefore, the above explanations for describing the disclosed method are also used for describing the disclosed mechanism. The advantages of the mechanism correspond to those of the method and the corresponding embodiments thereof.

Optionally, the mechanism can comprise a memory unit that is arranged and embodied for storing data, such as for example the radius of the turning circle of the vehicle and/or data relating to the spatial requirement for performing a reverse-turning maneuver.

According to various embodiments, the processing unit can further be arranged and embodied for the determination and outputting of instructions for carrying out the reverse-turning maneuver. Instructions may comprise a route for the vehicle to follow to perform the maneuver.

According to further embodiments, the processing unit can further be arranged and embodied for the determination and outputting of steering angles, steering moments and/or speeds for traversing the determined route.

According to further embodiments, the processing unit can further be arranged and embodied for limiting a speed of the vehicle depending on the detected spatial conditions.

A vehicle according to the invention, for example, a motor vehicle, comprises one of the mechanisms described above for the assisted performance of a reverse-turning maneuver. Therefore, the above explanations for describing the mechanism according to the invention are also used for describing the vehicle according to the invention. The advantages of the vehicle according to the invention correspond to those of the mechanism according to the invention and the corresponding embodiments thereof.

In this case, a vehicle shall mean any mobile means of transport, i.e., both a land vehicle and a waterborne vehicle or aircraft, for example, a passenger vehicle.

The vehicle can be embodied as an autonomous or partly autonomous vehicle. An autonomous vehicle shall mean a self-propelled vehicle that can carry out all safety-critical functions for the entire driving procedure itself, so that control by the driver of the vehicle is not necessary at any time. The vehicle controls all functions from starting to stopping itself, including all parking functions. In addition, a manual mode can also be provided, in which a human driver of the vehicle controls all or some of the vehicle functions. If the driver of the vehicle controls some of the vehicle functions himself, it is a partly autonomous vehicle.

The invention is described in detail below using the figures and the associated description. In the figures:

### BRIEF DESCRIPTION OF THE DRAWINGS

FIG. 1 shows the performance of a J-turn and

FIG. 2 shows the performance of a double-L-turn.

### DETAILED DESCRIPTION

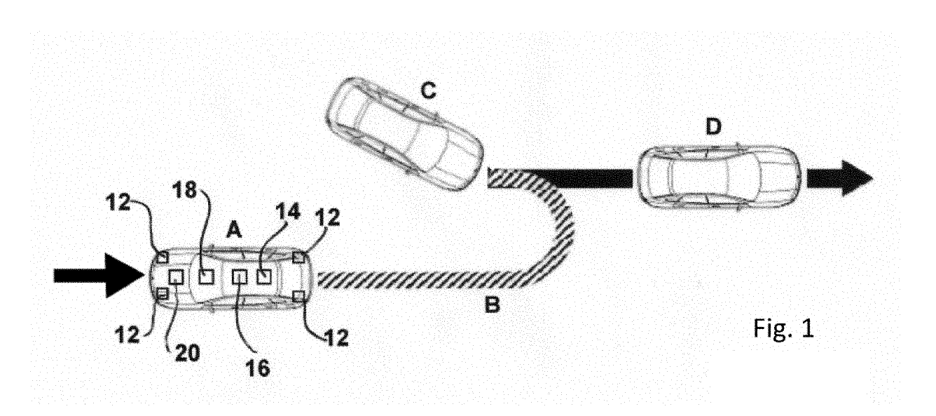

Referring to FIG. 1, a method for the assisted performance of a J-turn as a reverse-turning maneuver is described below. The method can for example be carried out by a police or other emergency service vehicle that comprises an appropriate mechanism.

During reversing, for example, assisted by a reversing assistant, the spatial conditions in the surroundings of the vehicle are detected by means of one or more non-contact sensors 12. Any appropriate type of sensor(s) known in the automotive arts, such as radar sensors and/or LIDAR sensors and/or camera sensors, can be used. A processing unit 14 receives information gathered by the sensor(s) 12 and determines, based at least in part on said information, whether the detected spatial conditions allow a reverse-turning maneuver (i.e. that there is sufficient unobstructed space adjacent to the vehicle to allow the reverse-turning maneuver). If it is determined that the maneuver is permitted, an audible, haptic or visible signal may be output to the driver of the vehicle by means, for example, of a human/machine interface unit 16.

If the driver of the vehicle agrees with executing the reverse-turning maneuver, he confirms the same by issuing a verbal/audible command, operating a button, or carrying out a certain steering movement, for example, a steering movement of an angle which lies above a certain threshold value and which corresponds to the steering movement that is necessary for carrying out the reverse-turning maneuver.

Receipt by the processing unit 14 of the driver's confirmation causes the processing unit to perform computerized determination and outputting of instructions for carrying out the reverse-turning maneuver. The instructions may comprise a route to be followed by the vehicle to perform the maneuver. The processing unit 14 may further output to a vehicle dynamics controller 18 of vehicle steering angles, steering torques and/or engine or vehicle speeds necessary for traversing the determined route. The vehicle dynamics controller 18 then commands one or more dynamics system 20 (for example, the vehicle's drivetrain system, steering system, or braking system) to operate in a partially or fully autonomous manner so that the vehicle performs the reverse-turning maneuver. For example, the dynamics controller 18 may direct a limiting of drive torque of the vehicle's engine or motor, and/or may autonomously control the steering and/or braking systems of the vehicle such that the necessary route (as determined and output by the processing unit 14) is followed by the vehicle. In addition, in the case of a vehicle with an automatic transmission, the dynamics controller 18 may autonomously control the selection of the necessary gear shifting range.

The J-turn is carried out by first reversing (A) the vehicle with a relatively high speed, then suddenly reducing the drive moment and a producing a larger steering angle, so that the momentum or inertia of the vehicle causes the front wheels of the vehicle to slide in an arc (B).

The front wheels slide in a curve, so that the forward-directed drive torque remains and the orientation of the vehicle changes from rearwards to forwards (C). At the same time, the appropriate transmission gear range is selected. This corresponds to the REVERSE range at the start of the reverse-turning maneuver and is then changed to the DRIVE range in the case of an automatic gearbox or into first gear in the case of a manual gearbox. The vehicle can now continue travelling rapidly forwards (D).

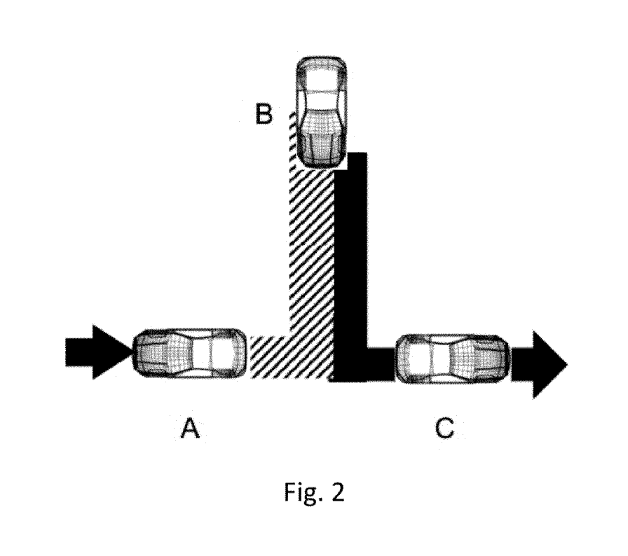

FIG. 2 shows schematically the performance of a double-L-turn. In contrast to the J-turn according to FIG. 1, no sliding of the front wheels is carried out in this case, but the vehicle moves from starting position A to position B, at an angle of approximately 90°, describing a first L movement. Then the vehicle movement is continued in the forward direction, wherein again a 90° turn (second L movement) is performed. Then the vehicle is located at position C and can continue moving according to the original driving direction, but now forwards.

The expression “and/or” used here, when it is used in a series of two or more elements, means that any of the mentioned elements can be used on its own, or any combination of two or more of the elements mentioned can be used. If for example a composition is described containing the components A, B and/or C, the composition can contain A alone; B alone; C alone; A and B in combination; A and C in combination; B and C in combination; or A, B, and C in combination.

What is claimed is:

1. A method for assisting performance of a reverse-turning maneuver of a vehicle, comprising:
operating a first sensor to determine that a reverse gear of the vehicle is engaged;
operating a non-contact sensor to detect spatial conditions adjacent to the vehicle;
operating a processing unit to determine whether the spatial conditions allow a reverse-turning maneuver;
operating the processing unit to generate a signal indicating to a driver of the vehicle that the spatial conditions allow the reverse-turning maneuver, and to receive a confirmation from the driver for performance of the maneuver; and
operating at least one vehicle dynamics system under autonomous control to execute the reverse-turning maneuver.

2. The method of claim 1, further comprising:
operating the processing unit to determine and output a route for carrying out the reverse-turning maneuver.

3. The method of claim 2, wherein the processing unit is further operated to determine and output at least one of a steering angle, steering torque, and a vehicle speed for traversing the determined route.

4. The method of claim 1, wherein the reverse-turning maneuver is at least one of a J-turn and a double-L-turn.

5. The method of claim 1, wherein a speed of the vehicle and/or a drive torque during performance of the maneuver is limited depending on the detected spatial conditions.

6. The method of claim 1, wherein the determination that the vehicle is reversing is made by an electronic controller detecting that a transmission of the vehicle is in a reverse gear.

7. A method for assisting performance of a reverse-turning maneuver of a vehicle, comprising:
determining that the vehicle is reversing;
operating a non-contact sensor to detect spatial conditions adjacent to the vehicle;
operating a processing unit to determine whether the spatial conditions allow a reverse-turning maneuver and to output . . . ; and
operating at least one vehicle dynamics system under autonomous control to execute the reverse-turning maneuver.

8. The method of claim 7, further comprising:
operating the processing unit to generate a signal indicating to a driver of the vehicle that the spatial conditions allow the reverse-turning maneuver.

9. The method of claim 8, wherein performance of the reverse-turning maneuver is contingent upon receipt by the processing unit of a confirmation from the driver for performance of the maneuver.

10. The method of claim 7, further comprising:
operating the processing unit to determine and output a route for carrying out the reverse-turning maneuver.

11. The method of claim 10, wherein the processing unit is further operated to determine and output at least one of a steering angle, steering torque, and a vehicle speed for traversing the determined route.

12. The method of claim 7, wherein the reverse-turning maneuver is at least one of a J-turn and a double-L-turn.

13. The method of claim 7, wherein a speed of the vehicle and/or a drive torque during performance of the maneuver is limited depending on the detected spatial conditions.

14. The method of claim 7, wherein the determination that the vehicle is reversing is made by an electronic controller detecting that a transmission of the vehicle is in a reverse gear.

15. Apparatus for assisting performance of a reverse-turning maneuver of a vehicle, comprising:
at least one sensor operative to detect a reversing movement of the vehicle;
at least one non-contact sensor operative to detect spatial conditions around the vehicle;
a processing unit operative to receive signals from the at least one non-contact sensor, to determine based on the signals whether the detected spatial conditions permit a reverse-turning maneuver, and to output instructions for autonomous performance of the maneuver if the spatial conditions allow the maneuver; and
at least one vehicle dynamics system autonomously operative to cause the vehicle to execute the maneuver.

16. The apparatus of claim 15, wherein the processing unit is further operative to determine and output a route for carrying out the reverse-turning maneuver.

17. The apparatus of claim 16, wherein the processing unit is further operative to determine and output at least one of a steering angle, a steering torque, and a vehicle speed for traversing the determined route.

18. The apparatus of claim 15, wherein the processing unit is further operative to limit at least one of a speed of the vehicle and a drive torque during performance of the maneuver depending on the detected spatial conditions.
